(19) United States
(12) Patent Application Publication
(10) Pub. No.: US 2014/0068066 A1
(43) Pub. Date: Mar. 6, 2014

(54) Method and System for Reporting Location Information of Mobile Terminal

(71) Applicant: Tencent Technology (Shenzhen) Company Limited, Shenzhen (CN)

(72) Inventor: Baohua Zhang, Shenzhen (CN)

(21) Appl. No.: 14/051,324

(22) Filed: Oct. 10, 2013

Related U.S. Application Data
(63) Continuation of application No. PCT/CN2012/072394, filed on Mar. 15, 2012.

(30) Foreign Application Priority Data
Apr. 19, 2011 (CN) 201110097835.X

(51) Int. Cl. H04L 29/08

(52) U.S. Cl. CPC H04L 29/08648
USPC 709/224

(57) ABSTRACT

The disclosure discloses a method and a system for reporting location information of mobile terminal. The method includes that: a service server sends page information to a connected mobile terminal, wherein the page information contains a label indicating reporting of location information is required; and after parsing out from the received page information the label indicating reporting of location information is required, the mobile terminal acquires the location information of the mobile terminal, and reports the obtained location information to the service server. With the present disclosure, reporting of the location information of a mobile terminal and the Location Based Service are implemented independent of the JavaScript.

### CROSS REFERENCE TO RELATED APPLICATIONS

This is a continuation application of International Patent Application No.: PCT/CN2012/072394, filed on Mar. 15, 2012, which claims priority to Chinese Patent

Application No.: 201110097835.X, filed on Apr. 19, 2011, the disclosure of which is incorporated by reference herein in its entirety.

### TECHNICAL FIELD

The present disclosure relates to the field of Location Based Service (LBS) in the mobile communication network, and in particular to a method and a system for reporting location information of a mobile terminal.

### BACKGROUND

According to the current specification of the World Wide Web Consortium (W3C), providing of a location based service on a browser is realized by means of the Geolocation API Specification, wherein API is the abbreviation for Application

Programming Interface. Specifically, Geolocation APIs are provided for a JavaScript engine at the browser, and a technician may develop the location based service using this set of APIs.

As mentioned above, for the LBS service, the browser is required to support the JavaScript engine. However, the browser mounted on a mobile terminal such as a mobile phone is currently unable to implement a JavaScript virtual machine due to hardware restrictions of the mobile terminal, and thus is unable to support the Geolocation API Specification. As the browser of the mobile terminal is unable to support a JavaScript, the mobile terminal is unable to report location information depending on the JavaScript, thus unable to implement the LBS service depending on the JavaScript. Therefore, it is required to come up with a method to implement reporting of the location information of the mobile terminal and the LBS service independent of the JavaScript on the browser of the mobile terminal.

### SUMMARY

In view of the above, the main objective of the disclosure is to provide a method and a system for reporting location information of a mobile terminal, to implement reporting of the location information of the mobile terminal and the LBS service independent of the JavaScript.

To achieve the aforementioned objective, the technical solution of the present disclosure is implemented as follows.

The present disclosure provides a method for reporting location information of a mobile terminal, including:

a service server sends page information to a mobile terminal connected with the service server, wherein the page information contains a label indicating reporting of location information is required; and

the service server receives the location information reported by the mobile terminal, wherein the location information is the location information of the mobile terminal itself obtained after the mobile terminal parses out the label from the received page information.

The label may contain a Universal Resource Locator (URL) for reporting the location information, to instruct the mobile terminal to report the obtained location information to the designated URL in the label.

The label may contain a threshold indicating re-reporting of the location information is required when the change of the location exceeds the threshold, to instruct the mobile terminal to report the location information of the mobile terminal again to the service server when the mobile terminal detects that the location change of the mobile terminal exceeds the threshold.

The location information may be encoded by the mobile terminal into an Extensible

Markup Language (XML) file, which is then sent to the service server.

The location information may be at least one of

Global Positioning System (GPS) information, base station information, and wireless fidelity (WIFI) Internet Protocol (IP) address information.

The present disclosure further provides a method for location information of a mobile terminal, including:

a mobile terminal receives page information sent by a service server, wherein the page information contains a label indicating reporting of location information is required; and

after parsing out from the received page information the label indicating reporting of location information is required, the mobile terminal acquires the location information of the mobile terminal, and reports the obtained location information to the service server.

The label may contain a Universal Resource Locator (URL) for reporting the location information, and

the mobile terminal may report the obtained location information to the designated URL in the label.

The label may contain a threshold indicating re-reporting of the location information is required when the change of the location exceeds the threshold, and

the mobile terminal may report the location information of the mobile terminal again to the service server when the mobile terminal detects that the location change of the mobile terminal exceeds the threshold.

The present disclosure further provides a system for reporting location information of a mobile terminal, including a mobile terminal and a service server, wherein

the service server is configured to send page information to the mobile terminal connected with the service server, wherein the page information contains a label indicating reporting of location information is required; and

the mobile terminal is configured to, after parsing out from the received page information the label indicating reporting of location information is required, acquire the location information of the mobile terminal, and report the obtained location information to the service server.

The mobile terminal may be further configured to encode the obtained location information into an Extensible Markup Language (XML) file, and report the XML file to the service server.

The location information may be at least one of

Global Positioning System (GPS) information, base station information, and wireless fidelity (WIFI) Internet Protocol (IP) address information.

The present disclosure further provides a service server, including:

a page information sending module configured to send page information to a mobile terminal connected with the service server, wherein the page information contains a label indicating reporting of location information is required; and

a location information receiving module configured to receive the location information reported by the mobile terminal, wherein the location information is the location information of the mobile terminal itself obtained after the mobile terminal parses out the label from the received page information.

The label may contain a Universal Resource Locator (URL) for reporting the location information, and

the page information sending module may be further configured to request the mobile terminal to report the obtained location information to the designated URL in the label.

The label may contain a threshold indicating re-reporting of the location information is required when the change of the location exceeds the threshold, and

the page information sending module is further configured to request the mobile terminal to report the location information of the mobile terminal again to the service server when the mobile terminal detects that the location change of the mobile terminal exceeds the threshold.

The present disclosure further provides a mobile terminal, including:

a page information receiving module, configured to receive page information sent by a service server, wherein the page information contains a label indicating reporting of location information is required; and

a location information reporting module, configured to, after parsing out from the received page information the label indicating reporting of location information is required, acquire the location information of the mobile terminal, and report the obtained location information to the service server.

The label may contain a Universal Resource Locator (URL) for reporting the location information, and

the location information reporting module may be further configured to report the obtained location information to the designated URL in the label.

The label may contain a threshold indicating re-reporting of the location information is required when the change of the location exceeds the threshold, and

the location information reporting module may be further configured to report the location information of the mobile terminal again to the service server when detecting that the location change of the mobile terminal exceeds the threshold.

With the method and the system for reporting location information of a mobile terminal provided by the present disclosure, a service server sends page information to a connected mobile terminal, wherein the page information contains a label indicating reporting of location information is required; and after parsing out from the received page information the label indicating reporting of location information is required, the mobile terminal acquires the location information of the mobile terminal and reports the obtained location information to the service server. With the present disclosure, reporting of the location information of amobile terminal and the LBS service are implemented independent of the JavaScript.

### BRIEF DESCRIPTION OF THE DRAWINGS

FIG. 1 is a flowchart of a method for reporting location information of a mobile terminal according to an embodiment of the present disclosure;

FIG. 2 is a flowchart of the method for implementing an LBS service according to an embodiment of the present disclosure;

FIG. 3 is a schematic view of a structure of a system for reporting location information of a mobile terminal according to an embodiment of the present disclosure.

### DETAILED DESCRIPTION OF THE INVENTION

The technical solution of the present disclosure is further elaborated hereinafter with reference to the figures and specific embodiments.

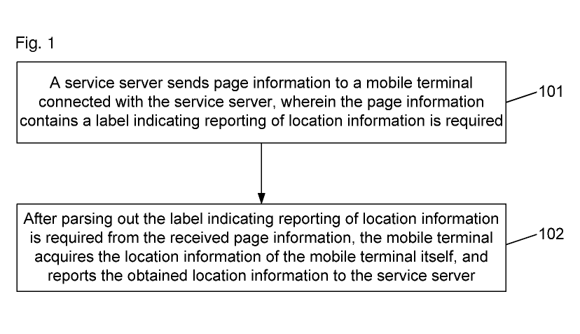

A method for reporting location information of a mobile terminal provided by an embodiment of the present disclosure, as shown in FIG. 1, mainly includes the following steps.

Step 101: a service server sends page information to a mobile terminal connected with the service server, wherein the page information contains a label indicating reporting of location information is required.

After the mobile terminal is connected to the service server, the service server is required to send the page information to the connected mobile terminal, wherein the page information may carry a customized label indicating reporting of location information is required. The customized label is configured to instruct the mobile terminal to report the location information of the mobile terminal itself.

Step 102: the service server receives the location information reported by the mobile terminal according to the label, wherein the location information is the location information of the mobile terminal itself obtained after the mobile terminal parses out the label from the received page information.

After parsing out the label indicating reporting of location information is required from the received page information, the mobile terminal acquires the location information of the mobile terminal itself, and reports the obtained location information to the service server.

The label may contain a Universal Resource Locator (URL) for reporting the location information. Accordingly, the mobile terminal is required to report the obtained location information to the designated URL in the label.

The label may also contain a threshold indicating re-reporting of the location information is required when the change of the location exceeds the threshold. Accordingly, the mobile terminal re-reports the current location information of the mobile terminal itself to the service server when the mobile terminal detects that the location change of the mobile terminal exceeds the threshold.

In addition, the location information may include at least one kind of the following information: Global Positioning System (GPS) information, base station information, and wireless fidelity (WIFI) Internet Protocol (IP) address information.

When the location information is the GPS information (i.e., GPS longitude and latitude information), the aforementioned threshold may be the longitude and latitude ranges of the Geolocation. Accordingly, when the mobile terminal detects that the current GPS information of the mobile terminal itself is not within the longitude and latitude ranges, the mobile terminal reports the current location information of the mobile terminal itself again to the service server.

When the location information is the base station information (e.g., a base station ID), the aforementioned threshold may be the event that the base station ID changes. Accordingly, when the mobile terminal detects that the current base station ID has changed, the mobile terminal reports the current location information of the mobile terminal itself again to the service server.

When the location information is the WIFI IP address information, the aforementioned threshold may be the event that the WIFI IP address information changes. Accordingly, when the mobile terminal detects that the current WIFI IP address information of the mobile terminal has changed, the mobile terminal reports the current location information of the mobile terminal itself again to the service server.

A method for implementing an LBS service according to an embodiment of the present disclosure is elaborated hereinafter with reference to FIG. 2 based on the method for reporting location information of a mobile terminal shown in FIG. 1. As shown in FIG. 2, the method mainly includes the following steps.

Step 201: a mobile terminal starts up the browser of the mobile terminal.

Step 202: the mobile terminal requests a service from the service server.

Step 203: the service server sends the page information to the connected mobile terminal, wherein the page information contains a customized label indicating the mobile terminal is required to report its location information. The customized label is configured to instruct the mobile terminal to report the location information of the mobile terminal itself.

By saying that the page information contains the customized label indicating reporting of the location information is required, it means to insert in the page the following customized element:

<!--mttlocationdetect action=“http://ServiceIP:Port/path” threshold=“1km|newcellid”--><!--/mttlocationdetect-->.

The URL for reporting the location information is saved in the attribute action, the threshold of displacement data is saved in the attribute threshold. The mobile terminal should report new location information again to the service server when this threshold is exceeded.

When the location information is the GPS information (i.e., GPS longitude and latitude information), the aforementioned threshold may be the longitude and latitude ranges of the Geolocation. Accordingly, when the mobile terminal detects that the current GPS information of the mobile terminal itself is not within the longitude and latitude ranges, the mobile terminal reports the current location information of the mobile terminal itself again to the service server.

When the location information is the base station information (e.g., a base station ID), the aforementioned threshold may be the event that the base station ID changes. Accordingly, when the mobile terminal detects that the current base station ID has changed, the mobile terminal is required to report the current location information of the mobile terminal itself again to the service server.

When the location information is the WIFI IP address information, the aforementioned threshold may be the event that the WIFI IP address information changes. Accordingly, when the mobile terminal detects that the current WIFI IP address information of the mobile terminal has changed, the mobile terminal is required to report the current location information of the mobile terminal itself again to the service server.

Step 204: the mobile terminal detects the label indicating reporting of location information is required from the received page information.

Step 205: the mobile terminal acquires its current location information.

The location information may include at least one kind of the following information: GPS information, base station information, and WIFI IP address information.

Preferably, if the mobile terminal supports a GPS function and the current GPS information is available, the GPS information is acquired by invoking a local API. If the mobile terminal does not support the GPS or the GPS information is unavailable, the mobile terminal may acquire its GPS information by inquiring from a location server.

Step 206: the mobile terminal asks a user of the mobile terminal whether to allow reporting the location information.

Step 207: after obtaining an approval from the user, the mobile terminal reports the obtained location information to the service server.

The mobile terminal may encode the obtained location information into an Extensible Markup Language (XML) file, and upload the XML file to the service server by way of POST. POST is an operation in a HyperText Transfer Protocol (HTTP), which means to mail, to submit. Data, such as one XML file, may be submitted to the server by this way in HTTP.

For example, after obtaining the GPS information of the mobile terminal itself, the mobile terminal uploads the GPS information to the URL designated by action by way of POST, and the data are encoded in text/plain format, with the following content:

longitude=xxx.xxx\r\n,

latitude=xxx.xxx\r\n,

altitude=xxx.xxx\r\n,

wherein xxx.xxx represents specific longitude, latitude, and altitude information, and \r\n represents carriage return and line feed.

Steps 208˜209: the mobile terminal reports the current location information of the mobile terminal again to the service server when the mobile terminal detects that the location change of the mobile terminal exceeds the threshold, to inform the service server the modification in the location of the mobile terminal.

In the page information containing an mttlocationdetect type, if change in the location shift exceeds the threshold specified in the attribute threshold, the mobile terminal is required to report the current location information again to the service server, to maintain the updated state of the location information.

If the threshold is the longitude and latitude ranges of the Geolocation, the mobile terminal reports the current location information of the mobile terminal again to the service server when the mobile terminal detects that the current GPS information of the mobile terminal is not within the longitude and latitude ranges.

If the threshold is the event that the base station ID changes, the mobile terminal reports the current location information of the mobile terminal again to the service server when the mobile terminal detects that the current base station ID has changed.

If the threshold is the event that the WIFI IP address information changes, the mobile terminal reports the current location information of the mobile terminal again to the service server when the mobile terminal detects that the current WIFI IP address information of the mobile terminal has changed.

Subsequently, the service server executes the normal LBS service interacting process with the mobile terminal according to the location information reported by the mobile terminal.

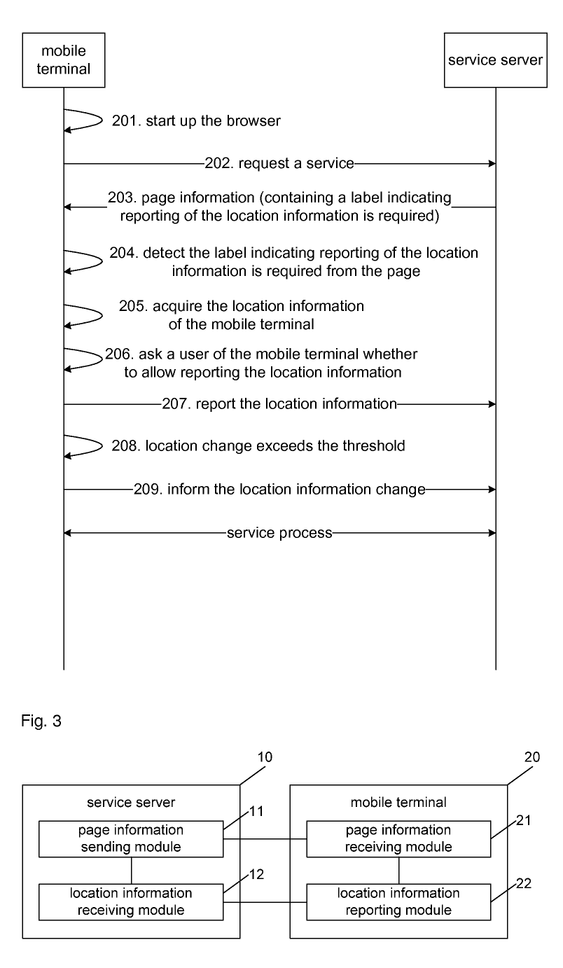

Corresponding to the aforementioned method for reporting the location information of a mobile terminal, the present disclosure further provides a system for reporting location information of a mobile terminal, as shown in FIG. 3, including a service server 10 and a mobile terminal 20. The service server 10 is configured to send page information to the connected mobile terminal 20, wherein the page information contains a label indicating reporting of location information is required. The mobile terminal 20 is configured to, after parsing out from the received page information the label indicating reporting of location information is required, acquire the location information of the mobile terminal 20, and report the obtained location information to the service server 10.

Preferably, the label may contain an URL for reporting the location information. The mobile terminal 20 is further configured to report the obtained location information to the designated URL in the label.

Preferably, the label may contain a threshold indicating re-reporting of the location information is required when the change of the location exceeds the threshold. The mobile terminal 20 is further configured to report the location information of the mobile terminal 20 again to the service server 10 when the mobile terminal 20 detects that the location change of the mobile terminal exceeds the threshold.

The mobile terminal 20 may be further configured to encode the obtained location information into an XML file, and report the XML file to the service server 10.

The location information is at least one kind of the following information: GPS information, base station information, and WIFI IP address information. When the base station information or the WIFI IP address information is reported by the mobile terminal 20, the service server 10 may automatically convert the base station information or the WIFI IP address information into the corresponding longitude and latitude information.

Preferably, the service server 10 further includes a page information sending module 11 and a location information receiving module 12. The page information sending module 11 is configured to send page information to the connected mobile terminal 20, wherein the page information contains a label indicating reporting of location information is required. The location information receiving module 12 is configured to receive the location information reported by the mobile terminal 20 according to the label, wherein the location information is the location information of the mobile terminal 20 itself obtained after the mobile terminal 20 parses out the label from the received page information.

Furthermore, the label contains a URL for reporting the location information, and

the page information sending module 11 is further configured to request the mobile terminal 20 to report the obtained location information to the designated URL in the label.

Furthermore, the label contains a threshold indicating re-reporting of the location information is required when the change of the location exceeds the threshold, and

the page information sending module 11 is further configured to request the mobile terminal 20 to report the location information of the mobile terminal 20 again to the service server 10 when the mobile terminal 20 detects that the location change of the mobile terminal 20 exceeds the threshold.

Preferably, the mobile terminal 20 further includes a page information receiving module 21 and a location information reporting module 22. The page information receiving module 21 is configured to receive page information sent by a service server 10, wherein the page information contains a label indicating reporting of location information is required. The location information reporting module 22 is configured to, after parsing out from the received page information the label indicating reporting of location information is required, acquire the location information of the mobile terminal 20, and report the obtained location information to the service server 10.

Furthermore, the label contains a Universal Resource Locator (URL) for reporting the location information, and

accordingly, the location information reporting module 22 is further configured to report the obtained location information to the designated URL in the label.

Furthermore, the label contains a threshold indicating re-reporting of the location information is required when the change of the location exceeds the threshold, and accordingly, the location information reporting module 22 is further configured to report the location information of the mobile terminal 20 again to the service server 10 when detecting that the location change of the mobile terminal 20 exceeds the threshold.

What described are merely preferred embodiments of the present disclosure and are not intended to limit the scope of the present disclosure.

1. A method for reporting location information of a mobile terminal, comprising:
sending, by a service server, page information to a mobile terminal connected with the service server, wherein the page information contains a label indicating reporting of location information is required; and
receiving, by the service server, the location information reported by the mobile terminal, wherein the location information is the location information of the mobile terminal itself obtained after the mobile terminal parses out the label from the received page information.

2. The method for reporting location information of a mobile terminal according to claim 1, wherein the label contains a Universal Resource Locator (URL) for reporting the location information, to instruct the mobile terminal to report the obtained location information to the designated URL in the label.

3. The method for reporting location information of a mobile terminal according to claim 1, wherein the label contains a threshold indicating re-reporting of the location information is required when the change of the location exceeds the threshold, to instruct the mobile terminal to report the location information of the mobile terminal again to the service server when the mobile terminal detects that the location change of the mobile terminal exceeds the threshold.

4. The method for reporting location information of a mobile terminal according to claim 1, wherein the location information is encoded by the mobile terminal into an Extensible Markup Language (XML) file and the XML file is reported to the service server.

5. The method for reporting location information of a mobile terminal according to claim 1, wherein the location information is at least one of
Global Positioning System (GPS) information, base station information, and wireless fidelity (WIFI) Internet Protocol (IP) address information.

6. A method for reporting location information of a mobile terminal, comprising:
receiving, by a mobile terminal, page information sent by a service server, wherein the page information contains a label indicating reporting of location information is required; and
after the mobile terminal parses out from the received page information the label indicating reporting of location information is required, acquiring, by the mobile terminal, the location information of the mobile terminal, and reporting, by the mobile terminal, the obtained location information to the service server.

7. The method for reporting location information of a mobile terminal according to claim 6, wherein the label contains a Universal Resource Locator (URL) for reporting the location information, and wherein the obtained location information is sent by the mobile terminal to the designated URL in the label.

8. The method for reporting location information of a mobile terminal according to claim 6, wherein the label contains a threshold indicating re-reporting of the location information is required when the change of the location exceeds the threshold, and
the location information of the mobile terminal is reported by the mobile terminal again to the service server when the mobile terminal detects that the location change of the mobile terminal exceeds the threshold.

9. A system for reporting location information of a mobile terminal, comprising a mobile terminal and a service server, wherein
the service server is configured to send page information to the mobile terminal connected with the service server, wherein the page information contains a label indicating reporting of location information is required; and
the mobile terminal is configured to, after parsing out from the received page information the label indicating reporting of location information is required, acquire the location information of the mobile terminal, and report the obtained location information to the service server.

10. The system for reporting location information of a mobile terminal according to claim 9, wherein the mobile terminal is further configured to encode the obtained location information into an Extensible Markup Language (XML) file, and report the XML file to the service server.

11. The system for reporting location information of a mobile terminal according to claim 9, wherein the location information is at least one of
Global Positioning System (GPS) information, base station information, and wireless fidelity (WIFI) Internet Protocol (IP) address information.

12. A service server, comprising:
a page information sending module configured to send page information to a mobile terminal connected with the service server, wherein the page information contains a label indicating reporting of location information is required; and
a location information receiving module configured to receive the location information reported by the mobile terminal, wherein the location information is the location information of the mobile terminal itself obtained after the mobile terminal parses out the label from the received page information.

13. The service server according to claim 12, wherein the label contains a Universal Resource Locator (URL) for reporting the location information, and
wherein the page information sending module is further configured to request the mobile terminal to report the obtained location information to the designated URL in the label.

14. The service server according to claim 12, wherein the label contains a threshold indicating re-reporting of the location information is required when the change of the location exceeds the threshold, and
the page information sending module is further configured to request the mobile terminal to report the location information of the mobile terminal again to the service server when the mobile terminal detects that the location change of the mobile terminal exceeds the threshold.

15. A mobile terminal, comprising:
a page information receiving module, configured to receive page information sent by a service server, wherein the page information contains a label indicating reporting of location information is required; and
a location information reporting module, configured to, after parsing out from the received page information the label indicating reporting of location information is required, acquire the location information of the mobile terminal, and report the obtained location information to the service server.

16. The mobile terminal according to claim 15, wherein the label contains a Universal Resource Locator (URL) for reporting the location information, and
wherein the location information reporting module is further configured to report the obtained location information to the designated URL in the label.

17. The mobile terminal according to claim 15, wherein the label contains a threshold indicating re-reporting of the location information is required when the change of the location exceeds the threshold, and
wherein the location information reporting module is further configured to report the location information of the mobile terminal again to the service server when detecting that the location change of the mobile terminal exceeds the threshold.

18. The method for reporting location information of a mobile terminal according to claim 2, wherein the location information is encoded by the mobile terminal into an Extensible Markup Language (XML) file and the XML file is reported to the service server.

19. The method for reporting location information of a mobile terminal according to claim 2, wherein the location information is at least one of
Global Positioning System (GPS) information, base station information, and wireless fidelity (WIFI) Internet Protocol (IP) address information.
